(19) United States
(12) Patent Application Publication
(10) Pub. No.: US 2017/0125058 A1
(43) Pub. Date: May 4, 2017

(54) METHOD FOR AUTOMATICALLY PUBLISHING ACTION VIDEOS TO ONLINE SOCIAL NETWORKS

(71) Applicant: Fusar Technologies, Inc., Jersey City, NJ (US)

(72) Inventors: Ryan T. Shearman, Jersey City, NJ (US); Todd H. Rushing, Hackensack, NJ (US); Daniel R. Bersak, Queens, NY (US); Clayton Patton, Putnam Valley, NY (US)

(21) Appl. No.: 15/339,605

(22) Filed: Oct. 31, 2016

Related U.S. Application Data
(60) Provisional application No. 62/249,053, filed on Oct. 30, 2015.

(51) Int. Cl. G11B 27/031; H04N 5/91; H04N 5/77; H04N 5/907; H04L 29/08; G11B 31/00

(52) U.S. Cl. CPC G11B 27/031; H04L 67/06; G11B 31/006; H04N 5/772; H04N 5/907; H04N 5/91

(57) ABSTRACT

One variation of a method for automatically publishing action videos to online social networks includes: recording video frames to a circular buffer of a preset duration; writing a first sequence of video frames from the buffer to a local memory, the first sequence of video frames previously recorded to the buffer over a first duration from a start time to a first time, the first duration a subset of the preset duration; writing a second sequence of video frames to a local memory, the second sequence of video frames recorded over a second duration from the first time to a final time; processing the first sequence of video frames and the second sequence of video frames into a first video of a first format and of a first length corresponding to a first online social network; and automatically uploading the first video to the first online social network.

### CROSS-REFERENCE TO RELATED APPLICATIONS

This application claims the benefit of U.S. Provisional Application No. 62/249,053, filed on 30 Oct. 2015, which is incorporated in its entirety by this reference.

This application is related to U.S. patent application Ser. No. 14/821,426, filed on 7 Aug. 2015, which is incorporated in its entirety by this reference.

### TECHNICAL FIELD

This invention relates generally to the digital video publishing and more specifically to a new and useful method for automatically publishing action videos to online social networks in the field of digital video publishing.

### BRIEF DESCRIPTION OF THE FIGURES

FIG. 1 is a flowchart representation of a method;

FIG. 2 is a flowchart representation of one variation of the method; and

FIG. 3 is a graphical representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

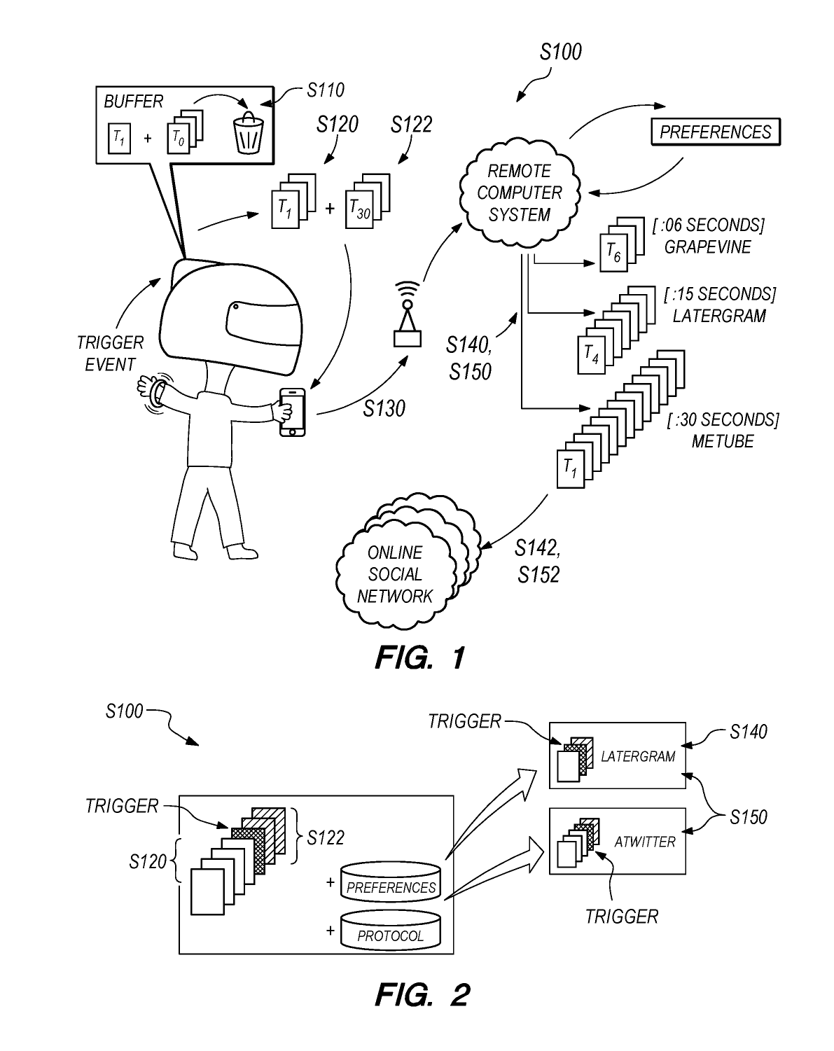

As shown in FIG. 1, a method for automatically publishing action videos to online social networks includes: at a camera carried by a user, recording video frames to a circular buffer of a preset duration in Block S110; in response to receipt of a manual input by the user at a first time, writing a first sequence of video frames from the buffer to a local memory in Block S120, the first sequence of video frames previously recorded to the buffer over a first duration from a start time to the first time, the first duration a subset of the preset duration; in response to receipt of the manual input, writing a second sequence of video frames to a local memory, the second sequence of video frames recorded over a second duration from the first time to a final time in Block S122; processing the first sequence of video frames and the second sequence of video frames into a first video of a first format and of a first length corresponding to a first online social network in Block S140; and automatically uploading the first video to the first online social network in Block S142.

One variation of the method includes: at a camera worn by a user, recording video frames to a circular buffer of a preset duration in Block S110; in response to receipt of a manual input by the user at a first time, writing a first sequence of video frames from the buffer to a local memory in Block S120, the first sequence of video frames previously recorded to the buffer over a first duration from a start time to the first time, the first duration a subset of the preset duration; in response to receipt of the manual input, writing a second sequence of video frames to a local memory in Block S122, the second sequence of video frames recorded over a second duration from the first time to a final time; uploading the first sequence of video frames and the second sequence of video frames to a remote computer system in Block S130; at the computer system, processing the first sequence of video frames and the second sequence of video frames into a first video of a first format and of a first length corresponding to a first online media resource in Block S140; automatically uploading the first video to the first online media network in Block S142; at the computer system, processing the first sequence of video frames and the second sequence of video frames into a second video of a second format and a second length corresponding to a second online media resource in Block S150, the second length different from the first length and less than the sum of the first duration and the second duration; and automatically uploading the second video to the second online media network in Block S152.

### 2. Applications

Generally, the method can be executed by a computer system: to automatically collect a contiguous sequence of video frames recorded both before and after a single manual input is received from a user; to automatically process the contiguous sequence of video frames into videos of lengths and formats corresponding to multiple online media networks; and to automatically upload the processed videos to their corresponding online media networks in response to the single manual input supplied by the user. While riding a motorcycle, skiing, snowboarding, skateboarding, boating, racing, street-luging, parasailing, surfing, or engaging in any other action or action sport, a user can carry or wear one or more wireless-enabled computing devices including a camera, and the user can enter a single input into one of these computing devices to trigger execution on Blocks S120, S1220, S130, etc. of the method. In particular, the computing device(s) can execute Blocks of the method to automatically capture new video frames, combine the new video frames with video frames captured before the user input, to process online social media network-ready videos, and to automatically publish these videos to their corresponding online social media network in response to one input (e.g., “one click”) from the user.

For example, an amateur skier can select an input region on his helmet system or other local computing device after landing a jump in order to trigger the computing device(s) to process video frames written to a circular buffer on his helmet system during the jump and video frames written to the circular buffer while the amateur skier celebrates after landing the lamp into a single online social media network-ready video and to automatically publish this video to an online social media network previously elected by the amateur skier. In this example, for the same jump, a professional skier can select an input region on his helmet system or other local computing device just before or just after reaching the jump in order to trigger the computing device(s) to process video frames written to a circular buffer on his helmet system during the professional skier's approach to the jump and video frames written to the circular buffer as the professional skier lands the jump into a single online social media network-ready video and to automatically publish this video to an online social media network previously elected by the professional skier.

Blocks of the method can be executed—in combination with Blocks of an accident video recording and response method described in U.S. patent application Ser. No. 14/821,426—by a helmet system including a forward-facing camera. For example, while in operation, the helmet system can store video frames captured by the forward-facing camera to a circular buffer of limited duration (e.g., 30 seconds) and can write all video frames in the circular buffer to local memory for later access in response to detection of an accident involving the helmet system, as described in U.S. patent application Ser. No. 14/821,426. However, during regular operation (i.e., when an accident is not detected), in response to a manual input into the helmet system (or into a mobile computing device carried by the user and wirelessly paired with the helmet system) at a first time, the helmet system: can copy a first sequence of video frames of a first duration, currently stored in the local buffer, and current up to the first time to local memory; and record a second sequence of video frames through the camera over a second duration.

The helmet system, mobile computing device, or remote computer system then automatically processes the first and second sequences of video frames—which include a contiguous sequence of video frames captured both before and after the instance in time at which the input region is selected by the user—into a video of length, format, resolution, etc. suitable for publication on a particular online social media network. Once the video is completed, the helmet system, mobile computing device, or remote computer system automatically publishes the video to the online social media network. Therefore, in response to single selection of an input region by a user wearing the helmet system, Blocks of the method can be executed locally and/or remotely from the helmet system to retrieve a first sequence of video frames previously written to a circular buffer, to copy a second sequence of video frames subsequently written to the circular buffer, to process the first and second sequences of video frames into an online social media network-ready video, and to publish the video the online social media network. Blocks of the method can also be executed to transform the same first and second sequences of video frames into multiple videos ready for publication on multiple discrete online social media networks, such as according to length, format, and resolution requirements for each online social media network, and to automatically publish these videos to the corresponding online social media networks.

Though described herein as publishing video content to online social media networks, the method can additionally or alternatively be implemented to automatically publish video content to one or more private, personal, corporate, or other websites, blogs, online feeds, or native media applications, etc.

### 3. Devices

As shown in FIG. 1, Blocks of the method can be executed by one or more local computing devices worn, carried, or otherwise accessible by a user. Blocks of the method can additionally or alternatively be executed by a remote computer system implementing video processing protocols and interfacing with an online social media network. For example, a helmet system, as described in U.S. patent application Ser. No. 14/821,426, can execute Block S110 continuously while in operation, and the helmet system can then execute Blocks S120, S122, and S130 in response to receipt of a manual input into an input region on the helmet system or into a second computing device wirelessly paired with the helmet system. In this example, the second computing device can include a mobile computing device, such as a wireless-enabled watch worn by the user, a smartphone carried by the user, a wireless-enabled dongle including a momentary switch and mounted on a handlebar of a motorcycle or other vehicle operated by the user, a wireless-enabled dongle including a momentary switch and adhered to a surface of a surfboard ridden by the user, etc. The helmet system can be wirelessly paired with the second computing device, such as via a short-range wireless communication protocol, and can upload the first sequence of video frames and the second sequence of video frames to the second computing device in Block S130. For example, the helmet system can upload the first and second sequences of video frames to the second computing device asynchronously, such as once the complete first and second sequences of video frames have been written to local memory in the helmet system.

In the foregoing example, the second computing device transmits the first and second sequences of video frames—received from the helmet system—to a remote computer system (e.g., a remote server), such as via a second wireless communication protocol. The remote computer system can then implement video processing protocols to process the first and second sequences of video frames into one or more online social media network-ready videos. The user can also configure video processing protocols implemented by the remote computer system, such as through a native action video application executing on the second computing device or through a web browser. The remote computer system can automatically publish (e.g., upload, transmit) a first video—processed with a first video processing protocol associated with a first social media network—to the first social media network, and the remote computer system can similarly automatically publish a second video—processed according to a second video processing protocol associated with a second social media network—to the second social media network automatically. The helmet system can therefore record a contiguous sequence of video frames recorded on both sides of an input region selection (hereinafter a “trigger event”) and offload these video frames to a local computing device carried by the user, and the local computing device can upload these video frames to a remote computer system that processes these video frames and distributes processed videos to online social media networks.

Alternatively, the helmet system and/or the local computing device can process video frames into online social media network-ready videos (hereinafter “processed videos”) locally and can publish these videos directly to corresponding online social media networks. However, any other single or combination of local and/or remote computing devices can execute Blocks of the method.

Blocks of the method are described herein as executed by a helmet system including a forward-facing camera. However, these Blocks of the method can be executed by any other computing device including one or more cameras, such as a color CCD camera, a camera including a fisheye lens, a 180° camera system, or a 360° camera system, etc. integrated into or mounted onto a helmet or a smartphone strung from a neckband and worn around the user's neck. Furthermore, unless otherwise noted, “computer system” recited hereinafter describes any one or more of a helmet system, wearable device, mobile computing device, remote computer system, or other local or remote computing device executing one or more Blocks of the method.

### 4. Preferences

The computer system can include a user-configurable preferences database that stores the user's preferences for video processing parameters, such as video format, resolution, bitrate, filters, and length. For example, a mobile computing device carried by the user and paired with the user's helmet system can execute a native action video application, and the user can set preferences for video processing parameters through the native action video application, which can upload these preferences to the remote computer system for subsequent application to video frames recorded by the user's helmet system in response to a trigger event.

In one implementation, the user's preferences database defines parameters for durations of video frame segments retrieved from the circular buffer before and after a trigger event. In particular, the database can define a first duration (or “look-back time”) over which a first contiguous sequence of video frames previously recorded to the circular buffer up to a trigger event is retrieved and combined with a second contiguous sequence of video frames recorded after the trigger event is detected. Similarly, the database can define a second duration (or “look-ahead time”) over which a second contiguous sequence of video frames is also written to memory after the trigger event and combined with the first contiguous sequence of video frames to form one complete, contiguous sequence of video frames of length equivalent to the sum of the first duration and the second duration.

The sum of the look-back time and the look-ahead time durations defines a total video frame duration (e.g., a maximum possible processed video duration). In one implementation, the total video frame duration is static and preset at 30 seconds, and the user can set the look-ahead time and look-back time according to personal preference. In the example above, prior to hitting the slopes, the professional skier can set the look-back time at 5 seconds and set the look-ahead time at 25 seconds; just after reaching a jump, the professional skier can select the input region, thereby triggering the computer system to generate a processed video including the 5 seconds before the skier hit the jump and the 25 seconds after the skier hits the jump. The computer system can therefore automatically process and publish a video for the professional skier in response to a single input by the professional skier, regardless of the outcome of the jump. In the example above, prior to hitting the slopes, the amateur user can set the look-back time to 25 seconds and the look-ahead time to 5 seconds; after landing a jump, the amateur skier can select the input region, thereby triggering the computer system to generate a processed video including the 25 seconds before the amateur skier landed a jump and the 5 seconds after the amateur skier landed the jump. The amateur skier can therefore decide whether to select the input region based on the outcome of his run, and the computer system can then automatically process and publish a video for the amateur skier. Furthermore, in this example, a third skier can set the look-back time to 12 seconds and the look-ahead time to 18 seconds in order to compensate for the third skier's preference for selecting the input region on his helmet system or mobile computing device while mid-air after hitting a jump; and a fourth skier can set the look-back time to 19 seconds and the look-ahead time to 11 seconds in order to compensate for the third skier's preference for selecting the input region on his helmet system or mobile computing device just before landing a jump.

The computer system can also automatically set the total video frame duration—and therefore the combined maximum of look-back and look-ahead times—based on the maximum video duration limit required by a set of online social media networks selected by the user for automatic publication of video content. For example, the user can interface with a preferences menu within a native action video application executing on his smartphone to activate a first online social media network associated with a 15 second video limit and a second online social media network associated with a 6 second video limit exclusively for automatic publication of video content, such as described below, and the computer system can automatically set the total video frame duration to 15 seconds. The computer system can then automatically adjust the look-back and look-ahead durations accordingly, such as by splitting the total video frame duration evenly across the look-back time and the look-ahead time.

However, the computer system can set the video frame duration according to any other schema and can function in any other way to write these parameters and/or user preferences to a local or remote user's preferences database. Furthermore, in response to adjustment of the look-back and look-ahead times, the computer system can push updated look-back and look-ahead times to the helmet system, and the helmet system can implement these times to collect the first and second sequences of videos, respectively, in Blocks S120 and S122 in response to a trigger event, as described below.

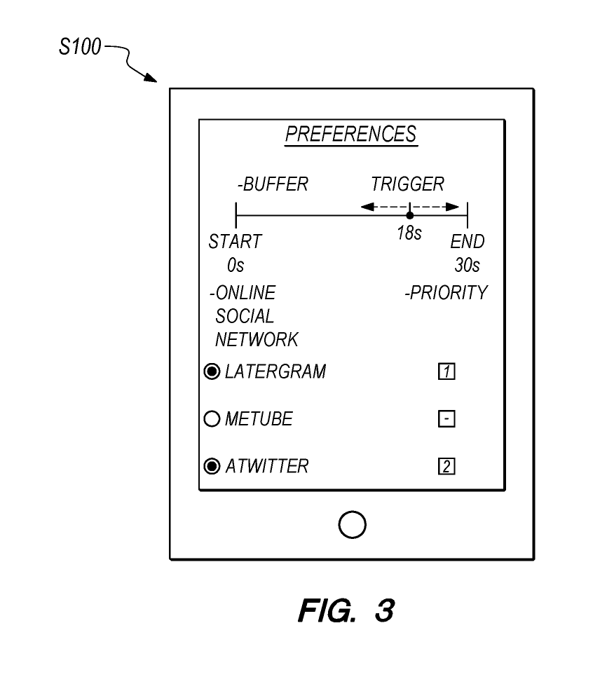

The computer system can also store the user's preferences for a subset of available online social media networks for which processed videos are automatically generated in Block S140 and uploaded in Block S142 in response to a single event trigger. For example, the computer system can support automatic generation and publication of processed videos to a set of online social media networks; and a preferences menu within the native action video application executing on the user's mobile computing device can display a textual and/or graphical representation of each supported online social media network adjacent a radio button, as shown in FIG. 3. The user can select and deselect (i.e., activate and deactivate) each supported online social media network for automatic video processing and publication by closing and opening each corresponding radio button within the preferences menu. In this example, the native action video application can also prompt the user to supply personal login information for each selected online social media network, and the user's mobile computing device can store these personal login data locally and/or upload these personal login data to the remote computer system, which can later access these personal login data in order to publish a processed video to a corresponding online social media network.

Furthermore, the native action video application can prompt the user to specify a preferred order (e.g., priority) for a subset of online social media networks thus activated by the user, as shown in FIG. 3. For example, if the user elects a subset of three online social media networks for automatic publication of videos in response to a single trigger event, the native action video application can prompt the user to set a primary, secondary, and tertiary online social media network from the subset. In this example, given limited local wireless network bandwidth to upload a complete sequence of video frames (i.e., a first sequence and a second sequence of video frames) from the user's mobile computing device (or from the helmet system) to the remote computer system, the mobile computing device can locally process the complete sequence of video frames into a primary processed video in Block S140 and then upload the primary processed video to the primary online social media network in Block S142, which may require more intensive processing locally at the mobile computing device but less wireless network bandwidth to complete Blocks S140 and S142; once local wireless network service supports a higher bandwidth, the mobile computing device can upload the complete sequence of video frames to the remote computer system for processing into a secondary processed video and a third processed video in Block S150 and automatic publication to the secondary and tertiary online social media networks, respectively, in Block S152.

### 5. Circular Buffer

Block S110 of the method recites, at a camera worn by a user, recording video frames to a circular buffer of a preset duration. Generally, in Block S110, the helmet system can capture a newest video frame—in a sequence of video frames—through one or more cameras arranged on the helmet system, to write the newest video frame to a circular buffer, and to discard an oldest video frame in the circular buffer in one sampling period. In particular, the helmet system continuously overwrites a circular buffer with new video frames in Block S110. For example, the helmet system can store a sequence of newest video frames spanning a static buffer duration of 30 seconds, as described in U.S. patent application Ser. No. 14/821,426. The helmet system can implement an adjustable or dynamic buffer duration, such as a buffer duration set manually by the user (e.g., through the native action video application executing on the user's smartphone) or a buffer duration that is inversely proportional to ground speed.

The helmet system can also maintain a second circular buffer of video frames captured by a rear-facing camera integrated into the helmet system, and the helmet system, second computing device, and/or remote computer system, etc. can execute Blocks of the method to automatically generate and publish a single processed video—for a single trigger event—that includes video frames captured by both the forward-facing and rear-facing cameras in the helmet system. For example, in Block S140, the remote computer system can generate a split-screen video from video frames captured by both the forward-facing and rear-facing cameras before and after a trigger event. Alternatively, in Block S140, the remote computer system can generate: a first processed video including video frames captured by the forward-facing camera before and after a trigger event; and a second processed video including video frames captured by the rear-facing camera before and after the same trigger event.

The helmet system can write video frames to the circular buffer within the helmet system. The helmet system can additionally or alternatively upload video frames (substantially in real-time) to a circular buffer on a smartphone or other computing device wirelessly paired to the helmet system.

The helmet system can record high-resolution, high-frame rate, and high-bitrate video content in Blocks S110, S120, and S122; and the helmet system, the user's mobile computing device, and/or the remote computer system can process this video content—locally and/or remotely—into lower-resolution, lower-frame rate, and/or lower-bitrate videos suitable for publication to one or more online social media networks in Block S140 and publish these videos to these online social media networks in Block S142 following a trigger event. The user can later retrieve the high-resolution, high-frame rate, and high-bitrate video content from the helmet system, from the mobile computing device, or from the remote computer system as desired. Alternatively, the helmet system can record lower-resolution, lower-frame rate, and lower-bitrate video content more suitable or immediately suitable for publication to one or more online social media networks. The helmet system, the user's mobile computing device, and/or the remote computer system can therefore publish video content to at least one online social media network with minimal video processing and substantially in real-time following a trigger event. However, the helmet system can record video frames at any resolution, frame rate, and/or bitrate, etc.

### 6. Trigger Event

Block S120 of the method recites, in response to receipt of a manual input by the user at a first time, writing a first sequence of video frames from the buffer to a local memory, wherein the first sequence of video frames were previously recorded to the buffer over a first duration from a start time to the first time, and wherein the first duration is a subset of the preset duration of the circular buffer. Similarly, Block S122 of the method recites, in response to receipt of the manual input, writing a second sequence of video frames to a local memory, wherein the second sequence of video frames is recorded over a second duration from the first time (i.e., the time of the trigger event) to a final time. Generally, in Blocks 120 and 122, the helmet system aggregates a first sequence of video frames stored in the circular buffer at an instant that a trigger event is detected and a second sequence of video frames recorded by the forward-facing camera over a limited period of time following the trigger event.

In one implementation in which the look-back time is equivalent to the buffer duration, the helmet system copies all video frames stored in the circular buffer to local memory in response to a trigger event. Similarly, for the look-back time that is less than the buffer duration, the helmet system can copy a most-recent subset of video frames stored in the circular buffer to local memory. Alternatively, the helmet system can lock the video frames corresponding to the look-back time in the circular buffer against deletion. Furthermore, in response to the trigger event, the helmet system can asynchronously copy video frames written to the circular buffer from the time of the trigger event to a time succeeding the trigger event by the look-ahead time to local memory. Alternatively, the helmet system can write video frames captured by the camera from the time of the trigger event to a time succeeding the trigger event by the look-ahead time directly to local memory substantially in real-time in response to the trigger event. However, the helmet system can collect and store the first and second sequences of video frames locally on the helmet system in any other suitable way or according to any other schema.

As described above, the helmet system can collect the first and second sequences of video frames in response to a single input applied manually by the user: directly onto an input region on the helmet system; onto a dongle wirelessly paired with the helmet system and mounted on a motorcycle, ATV, snowmobile, or other vehicle ridden by the user; onto a wearable device (e.g., wristband) worn by the user and wirelessly paired to the helmet system; into a smartphone carried by the user; or onto any other local input device carried or accessible to the user and wirelessly connected or wired to the helmet system. As described above, such a manual input can define a trigger event thus handled by the helmet system to collect the first and second sequences of video frames.

The helmet system can additionally or alternatively handle other types of trigger events. For example, the helmet system can include an accelerometer and/or other inertial sensor, can characterize outputs of the accelerometer as one of a subset of event types (e.g., accident, jump takeoff, jump landing, free-fall, etc.), and execute Blocks S120 and S122 in response to a characterization of a particular event type (e.g., jump takeoff, free-fall) previously elected as a trigger event. In another example, the helmet system can include a geospatial location sensor (e.g., GPS) and can execute Blocks S120 and S122 in response to an output of the geospatial location sensor indicating that the user has reached a destination previously elected as a trigger location. However, the helmet system can execute Blocks S120 and S122 in response to any other manual or automated trigger event.

The helmet system can also issue a warning to the user as a second time, succeeding the time of the trigger event by the look-ahead duration, approaches (i.e., as completion of recordation of the second sequence of video frames approaches). In one example, the helmet system is preconfigured to record the second sequence of video frames that is 15 seconds long; in this example, 5 seconds before the second time, the helmet system plays an audio warning through speakers inside the helmet system and renders an icon on an eyes-up display within the helmet system to indicate to the user that the second sequence of video frames is nearing completion. In this example, the helmet system can extend the look-ahead time of the second sequence by a preset extension duration (e.g., 10 seconds) in response to a second manual input entered by the user following the preceding trigger event and prior to expiration of the second time. The helmet system can therefore enable the user to extend the duration of the second sequence of video frames, and the helmet system can again prompt the user as expiration of the extension duration approaches, such as 5 seconds before the extension duration expires. In this implementation, when transforming video frames from this trigger event into a processed video for an online social media network requiring video of length less than the combined duration of the first and second sequences of video frames in Block S140, the computer system can shift the center of the processed video within the first and second sequences of video frames based on the second manual input supplied by the user to extend the second sequence of video frames. For example, in Block S140, the computer system can shift the center of the processed video forward by half of the first extension duration requested by the user and by an additional full extension duration for a second extension requested by the user. However, the helmet system can extend the second sequence of video frames by any other duration in response to any other form of user input in Block S122, and the computer system can transform the first and second sequences of video frames into processed videos according to any other schema in response to an extension requested by the user.

### 7. Data Transmission

Block S130 of the method recites uploading the first sequence of video frames and the second sequence of video frames to a remote computer system Generally, in Block S130, the helmet system and/or other local computing device cooperate to upload the first and second sequences of video frames collected in response to the trigger event (i.e., the “complete sequence of video frames”) to a remote computer system for processing and distribution to select online social media networks in Blocks S140 and S142, respectively.

In one implementation, the helmet system uploads the complete sequence of video frames to the second computing device via a first wireless protocol; and the second computing device then uploads the complete sequence of video frames—with an address for the remote computer system—to a local wireless network hub via a second wireless protocol in Block S130. In this implementation, the helmet system can capture and transmit the second sequence of video frames to the second computing device in real-time as each frame is recorded or in a bundle once recordation of the second sequence of video frames is complete. The second computing device thus downloads the complete sequence of video frames and transmits the video frames to a local wireless network hub (e.g., a cellular tower, a wireless local area network router), which then transmits the complete sequence of video frames to the remote computer system, such as over a computer network (e.g., the Internet). The remote computer system applies user preferences stored in the preferences database and video processing protocols to the complete sequence of video frames to produce a set of processed (i.e., online social media network-ready) videos, as described above in Blocks S140 and S150 and then uploads each processed video to its corresponding online social media network. Alternatively, the helmet system can upload the complete sequence of video frames directly to the remote computer system.

The helmet system and/or the mobile computing device can also upload select video frames from the complete sequence of video frames to the remote computer system based on local wireless network signal quality, local bandwidth cap availability, video frame processing requirements and video frame capture size (e.g., video format) for online social media networks currently set as active in the user's account, etc. For example, the user's mobile computing device can upload a first contiguous subset of video frames—from the complete sequences of video frames—15 MB in maximum file size to the remote computer system when local wireless network bandwidth is less than 2 Mbps, and the remote computer system can process the first contiguous subset of video frames into a first video 6 seconds in length in Block S140 and publish this first video to the first online social media network—characterized by a 6-second video length limit—in Block S142. In this example, the user's mobile computing device can later upload a second contiguous subset of video frames—from the complete sequences of video frames—50 MB in maximum file size to the remote computer system when local wireless network bandwidth is approximately 15 Mbps, and the remote computer system can similarly process the second contiguous subset of video frames into a second video 15 seconds in length in Block S150 and publish this second video to the second online social media network—characterized by a 15-second video length limit—in Block S152.

In the foregoing implementation, the helmet system and the second computing device can cooperate to capture, store, and transmit the completed sequence of video frames to the remote computer system, and the remote computer system can remotely generate and distribute processed videos to select online social media networks, which may require relatively minimal video processing at the helmet system and mobile computing device but which may also require more greater wireless network bandwidth to offload raw video frames to the remote computer system.

Alternatively, the helmet system and/or the mobile computing device can locally transform the complete sequence of video frames into one or more processed videos and then upload these processed videos to the remote computer system and/or directly to their corresponding online social media networks, which may require less wireless network bandwidth to offload compressed and processed videos but which may also require greater processing power at the helmet system and mobile computing device in order to generate the processed videos.

The helmet system and/or the mobile computing device can selectively implement the foregoing methods to upload both video frames and and/or processed video content to the remote computer system and/or to select online social media networks based on local wireless network signal quality, local bandwidth cap availability, etc., as described below. For example, when the local wireless network signal quality is poor and/or when the local bandwidth cap availability is low, the helmet system (and/or the user's mobile computing device) can: access a prioritized list of active online social media networks from the user's preferences database; retrieve video processing protocols, parameters, and user preferences for the primary online social media network specified in the user's preference database; implement methods and techniques described below to transform the complete sequence of video frames into a processed video suitable for publication on the primary online social media network; and then upload the processed video to the remote computer system. In this example, the remote computer system can then store a copy of the processed video locally and distribute the processed video to the primary online social media network for publication.

The helmet system (or mobile computing device) can thus process video frames when local wireless quality is insufficient to timely upload the complete sequences of video frames to the remote computer system for processing and can upload a processed video to the remote computer system (or directly to the primary online social media network), which may require significantly less wireless network bandwidth to upload, thereby minimizing time from the trigger event to publication of a video to at least one online social media network. In this example, the helmet system can continue to transform the complete sequence of video frames into processed videos for secondary, tertiary, and other online social media networks noted as active in the user's preferences database until local wireless network bandwidth and/or signal quality supports transmission of the complete sequence of video frames to the remote computer system. In the meantime, if a second online social media network is listed as active in the user's preferences database and specifies video resolution requirements less than that of the processed video and a video duration less than the duration of the processed video, the remote computer system can implement methods and techniques described below to transform the (first) processed video into a second processed video for publication to the second online social media network, thereby assuming video processing tasks from the helmet system.

Alternatively, the helmet system (or the mobile computing device) can prioritize generation of processed videos inversely with the predicted amount of time necessary to complete and upload each processed video. For example, when local wireless network bandwidth or quality is poor, the helmet system can generate a first processed video 6 seconds in duration and upload this first processed video to a first corresponding online social media network in order to achieve publication of at least one video encompassing the trigger to an online social media network in a minimal amount of time. The helmet system can then generate a second processed video 15 seconds in duration and upload this second processed video to a second corresponding online social media network if local wireless network bandwidth or quality still fails to support timely transmission of the complete sequence of video frames to the remote computer system. The helmet system (or the user's mobile computing device) can similarly prioritize lower-bandwidth transmissions directly to online social media networks with lower file size video uploads (e.g., lower-quality videos, shorter maximum video length).

The helmet system can therefore variably transmit video frames to the computer system or to one or more online social media networks. In particular, the helmet system (and/or the user's mobile computing device) may experience significant fluctuation in available bandwidth and signal quality when moving through an outdoor environment, and the helmet system can therefore transmit a maximum possible quality sequence of video frames by detecting and responding to available bandwidth substantially in real-time. The computer system can process a sequence of video frames of variable parameters thus received from the helmet system into a consistent set of parameters corresponding to a specific online social media network. In this variation, the computer system can implement variable video frame preset preference parameters configurable by the user, such as optimizing video frame transmission for the fastest speed possible or the highest quality possible.

### 8. Video Processing and Publication

Block S140 of the method recites processing the first sequence of video frames and the second sequence of video frames into a first video of a first format and of a first length corresponding to a first online social network. Generally, in Block S140, the computer system (e.g., the remote computer system, the helmet system, and/or the user's mobile computing device) functions to transform the complete sequence of video frames into a processed video ready for publication on an online social media network. In particular, the computer system can apply user preferences stored in the preferences database and video requirements for uploads to a particular online social media network to the complete sequence of video frames in order to generate a processed video of a length, format, resolution, bitrate, file size, etc. suitable for publication to the particular online social media network.

In one implementation, the computer system receives the complete sequence of video frames from the helmet system (or from the user's mobile computing device, etc.) and transcodes the video frames into prescribed output formats for the online social media network noted as active in the user's preference database. For example, the helmet system can upload source video frames characterized by 1080p resolution, 30 Mbps average bitrate, 7.1 channel audio, no visual filters, 60 frames per second, and a 30-second total length. The computer system can then process these source video frames: into a first processed video characterized by 480p resolution, 5 Mbps average bitrate, 2.1 channel audio, a sepia filter, 30 frames per second, and a 15-second total length in Block S140; and a second processed video characterized by 720p resolution, 15 Mbps average bitrate, 5.1 channel audio, a film grain filter, 24 frames per second, and a 30-second total length in Block S150. The computer system can then transmit the first processed video to a first online social media network and the second processed video to a second online social media network in Blocks S142 and S152, respectively.

The computer system can store or access video processing parameters, such as a video format, video length, resolution, visual filters, audio, and/or bitrate, etc. prescribed by each online social media network elected for publication of a processed video in response to a trigger event. For example, a first social media network may require that uploaded videos meet the following parameters: 480p resolution, 2.5 Mbps maximum bitrate, and 30 frames per second. In this example, the remote computer system (or the user's mobile computing device, etc.) can apply these parameters to a complete sequence of video frames spanning a trigger event to generate a video that meets the requirements of the first online social media network and can then transmit such a video to the first online social media network.

The computer system can similarly store combinations of video processing parameters unique to other online social media networks and selectively apply these parameters to complete sequences of video frames—in response to a trigger event—for online social media networks set as active in the user's preferences database. In one example, the computer system crops 7.5 seconds from each end of a complete sequence of video frames 30 seconds in length to extract a first set of video frames 15-seconds in length and then applies a first video processing protocol characterized by a 1:1 aspect ratio measuring 640×640 pixels, a film grain filter, 2-channel audio, and 1.5 Mbps bitrate encoded with a first video codec to the first set of video frames to generate a 15-second processed video for a first online social media network. In this example, the computer system can also apply a second video processing protocol characterized by a 16:10 aspect ratio measuring 3840×2160 pixels, a black and white filter, 7.1-channel audio, and a 35 Mbps bitrate encoded with a second video codec to the complete sequence of video frames to generate a 30-second processed video for a second online social media network.

In one implementation, the computer system centers midpoints of all processed videos to coincide with a video frame in the complete sequence of video frames corresponding to the trigger event. Alternatively, the computer system can center the midpoints of all processed videos at the center of the complete sequence of video frames. Yet alternatively, the computer system can set a duration of each processed video before the trigger event proportional to the current look-back time, and the computer system can set a duration of each processed video after the trigger event proportional to the current look-ahead time. The preferences window within the native action video application executing on the user's mobile computing device can also enable the user to customize a center point, a start point, an end point, and/or any other marker within a processed video thus generated in response to a trigger event. For example, the native action video application can enable the user to set a unique center point, start point, or end point for video production for each online social media network noted as active in the user's preferences database, as shown in FIG. 2.

The computer system can also add sound effects, visual filters, overlays (e.g., motion sensor data, speed), location (e.g., GPS location), textual media (e.g., the user's name, make and model of motorcycle that the user is riding), and/or other content previously entered or elected by the user to a processed video, such as based on user preferences stored for each online social media network that the user has set as active. The computer system can also dewarp, compress, crop, or color-adjust video frames, such as to generate rectified video frames for subsequent transformation into a processed video. However, the computer system can implement any other parameter, video processing protocol, or user preference when generating one or more processed videos in Blocks S140 and S150.

In another implementation, the helmet system (or the user's mobile computing device) aggregates the first and second sequences of video frames into a single multiplex video container format that contains all video frames for the trigger event and definitions for parameters required by each online social media network elected by the user, and the mobile computing device can upload the single multiplex video container format to the remote computer system. The remote computer system can then demultiplex the single multiplex video container format into multiple sequences of video frames corresponding to each user-elected online social media network in Blocks S140 and S150 based on the parameter definitions defined in the single multiplex video container format, and the remote computer system can then transmit these sequences of video frames to corresponding online social media network.

Yet alternatively, the user's mobile computing device or the remote computer system can crop a complete sequence of video frames to a length corresponding to a destination online social media network and then upload the cropped sequence of (raw) video frames directly to the online social media network, which can then process the cropped sequence of video frames according to internal video processing protocols.

### 9. Video Publication

Block S142 of the method recites automatically uploading the first video to the first online social network. Generally, in Block S142, the computer system can automatically push a processed video to its corresponding online social media network. In particular, after processing the complete sequence of video frames into one or more online social-network-ready videos, the computer system can transmit these online social-network-ready videos to the corresponding online social media network according to the publication specifications previously set by the user and without additional confirmation or input from the user.

The computer system can publish all processed videos simultaneously or as soon as available following completion of Blocks S140 and S150. Alternatively, the computer system can stage publication of processed videos to select online social media networks, such as according to a publication order previously set by the user and stored in the user's preferences database.

### 10. Additional Camera Views

In one variation, the system aggregates and processes video frames captured at multiple cameras into one processed video for automatic publication to an online social media network (or other digital media resource).

In one implementation, the helmet system writes video frames captured by a forward-facing camera in the helmet system to the circular buffer in Block S110 and records video frames from a rear-facing camera in the helmet system in Block S122 in response to a trigger event; in Block S140, the computer system then generates a processed video with video frames captured by the forward-facing camera preceding video frames captured by the rear-facing camera.

In another implementation: the helmet system writes video frames captured by a forward-facing camera in the helmet system to the circular buffer in Block Silo; the user's smartphone records video frames from an integrated forward-facing camera in Block S122 in response to a trigger event (e.g., selection of an input region within a native action video application executing on the smartphone); and, in Block S140, the computer system then generates a processed video with video frames captured by the forward-facing camera in the helmet system preceding video frames captured by the forward-facing camera in the smartphone. For example, a user wearing a helmet system while skating in a skate park can pass his smartphone to a friend, actuate the helmet system to write video frames captured by a forward-facing camera in the helmet system to the circular buffer, and then begin skating. While the user skates, the friend can record video of the user with the smartphone. In this example, in the midst of performing a trick, the user can select an input region on a wearable device (e.g., a wristband) wirelessly connected to the helmet, which can trigger the helmet system to retrieve video frames from the buffer in Block S120. The helmet system, the smartphone, or the remote computer system can then automatically retrieve a first set of pre-trigger event video frames from helmet system, retrieve a second set of post-trigger event video frames from the smartphone, and generate a processed video that cuts from a first-person view to a third-person view at a time corresponding to the trigger event (i.e., in the midst of the trick).

In yet another implementation: the helmet system writes video frames captured by a forward-facing camera in the helmet system to the circular buffer in Block Silo and broadcasts a record trigger to a nearby unmanned aerial vehicle (“UAV,” or “drone”) in response to a local trigger event (e.g., selection of the input region on a wirelessly-connect wearable device); the UAV tracks the helmet system and records video frames from an integrated camera in Block S122 in response to receipt of the record trigger from the helmet system; the UAV offloads images to the helmet system, to the user's smartphone, or directly to the remote computer system in Block S130, as described above; and the computer system then generates a processed video with video frames captured by the forward-facing camera in the helmet system preceding video frames captured by the camera in the UAV in Block S140.

The computer system can similarly interface with a camera integrated into one or more other devices wirelessly connected to the helmet system, to the user's smartphone, etc. to retrieve videos captured before and/or after a trigger event. However, the helmet system, smartphone, wearable device, remote camera system (e.g., UAV), remote computer system, and/or any other device can cooperate in any other suitable way to collect and process video frames from one or more cameras into a processed video for automatic publication to an online social media network or other online media resource.

### 11. Variations

As described above, the helmet system and/or the second computing device (e.g., the user's mobile computing device) can implement methods and techniques described above to produce a set of processed videos locally from a first and second sequence of video frames collected in Blocks S120 and S122 based on production parameters and user preference. In this variation, the helmet system and/or the second computing device can also upload the processed videos directly to their corresponding online social media networks. In this variation, the helmet system (in cooperation with or independently of the second computing device) can capture, store, and process video frames locally into online social-network-ready videos. For example, the helmet system and/or second computing device can perform coordinated parallel processing of the complete sequence of video frames to produce a processed video requiring relatively minimal bandwidth to upload to the remote computer system or to an online social media network directly.

Alternatively, as described above, the helmet system and/or the second computing device can implement preconfigured parameter preferences specifically for situations in which wireless network signal quality is poor, and the helmet system can capture video frames in a format optimized for online social media networks in lower quality settings when wireless network signal quality is poor. For example, in this variation, the helmet system can prioritize transmission of processed videos to online social media networks based on local wireless network signal quality assessed by the helmet system substantially in real time.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for automatically publishing action videos to online social networks comprising:
at a camera carried by a user:
recording video frames to a circular buffer of a preset duration;
in response to receipt of a manual input by the user at a first time, writing a first sequence of video frames from the buffer to a local memory, the first sequence of video frames previously recorded to the buffer over a first duration from a start time to the first time, the first duration a subset of the preset duration;
in response to receipt of the manual input, writing a second sequence of video frames to a local memory, the second sequence of video frames recorded over a second duration from the first time to a final time;
processing the first sequence of video frames and the second sequence of video frames into a first video of a first format and of a first length corresponding to a first online social network; and
automatically uploading the first video to the first online social network.
